(19) United States
(12) Patent Application Publication
(10) Pub. No.: US 2013/0151759 A1
(43) Pub. Date: Jun. 13, 2013

(54) STORAGE DEVICE AND OPERATING METHOD ELIMINATING DUPLICATE DATA STORAGE

(71) Applicants: HOJUN SHIM, YONGIN-SI (KR); YOUNGJIN CHO, SEOUL (KR)

(72) Inventors: HOJUN SHIM, YONGIN-SI (KR); YOUNGJIN CHO, SEOUL (KR)

(73) Assignee: SAMSUNG ELECTRONICS CO., LTD., SUWON-SI (KR)

(21) Appl. No.: 13/590,225

(22) Filed: Aug. 21, 2012

(30) Foreign Application Priority Data
Dec. 8, 2011 (KR) 10-2011-0131166

(51) Int. Cl. G06F 12/00; G06F 12/08

(52) U.S. Cl. 711/103; 711/E12.008; 711/E12.017

(57) ABSTRACT

A storage device includes storage media and a controller. The controller includes a de-duplication table that manages hash information for data stored in the storage media, and compares hash information for received write-requested data with hash information managed by the de-duplication table to determine whether the write-requested data is duplicate data.

### CROSS-REFERENCE TO RELATED APPLICATIONS

A claim for priority under 35 U.S.C §119 is made to Korean Patent Application No. 10-2011-0131166 filed Dec. 8, 2011, the subject matter of which is hereby incorporated by reference.

### BACKGROUND

The inventive concept relates to storage devices and operating methods for storage devices. More particularly, the inventive concept relates to storage devices including nonvolatile memory and operating methods that manage the de-duplication of stored data.

The efficient use of and access to available memory space in contemporary data storage devices are important design considerations. Different approaches have been used to minimize the amount of duplicate data stored by one or more host devices in a given storage device. Such “de-duplication” efforts are commonly provided by the file system of the host device, or by a host server. Unfortunately, these high level approaches necessarily create limitations for the constituent data storage devices, which should be relatively agnostic in their operation as between different host systems, file systems and operating systems.

Storage devices may be implemented using different types of semiconductor memory devices, and nonvolatile memory devices in particular. Nonvolatile memory device include EEPROM, FRAM, PRAM, MRAM, and the like. Among these options, flash memory (a particular type of EEPROM) has become particularly well adopted in contemporary digital systems and consumer electronics, such as MP3 players, camcorders, handheld phones, flash cards, solid state drive (SSD) and the like.

### SUMMARY

In one embodiment, the inventive concept provides a storage device comprising; a controller and storage media implemented with nonvolatile semiconductor memory, wherein the controller is configured to control access operations executed by the storage media in response to requests received from a host, and comprises; a Central Processing Unit (CPU) that controls receipt of a write request including write-request data, a hash key generator that provides a hash information including a new hash entry corresponding to the write-request data, and a de-duplication table that stores and manages hash information including a plurality of hash entries for stored data in the storage media, wherein in response to the write request, the CPU compares the new hash key with each one of the plurality of hash keys to determine whether the write-requested data is duplicate data for the stored data in the storage media.

In another embodiment, the inventive concept provides a method of operating a storage device comprising; generating hash information for received write-requested data, comparing the hash information with hash information managed by a de-duplication table to determine whether the write-requested data is duplicate data with stored data in the storage media, and if the write-requested data is duplicate data, mapping a logical address for the write-requested data to a physical address for corresponding stored data among the stored data of the storage media using a mapping table.

In another embodiment, the inventive concept provides a method of operating a memory system including storage media implemented with nonvolatile semiconductor memory, the method comprising; upon power-on of the storage media, constructing a mapping table correlating logical addresses for write-requested data and physical addresses for the storage media, and constructing a de-duplication table listing hash information for each one of stored data in the storage media including at least one of recent write data and recent read data, and then, receiving a write request including write-request data from a host, providing new hash information for the write-request data, and comparing the new hash information with the hash information listed in the de-duplication table to thereby determine whether or not the write-request data is duplicate data with any one of the stored data in the storage media.

### BRIEF DESCRIPTION OF THE FIGURES

The above and other objects and features of the inventive concept will become more apparent upon consideration of certain embodiments illustrated, in relevant portion, in the accompanying drawings.

FIG. 1 is a general block diagram of a memory system according to an embodiment of the inventive concept.

FIG. 2 is another block diagram illustrating a memory system according to an embodiment of the inventive concept.

FIG. 3 is a diagram describing operation of the hash key generator of FIG. 2.

FIG. 4 is a diagram describing operation of the CPU of FIG. 2.

FIG. 5 is a diagram illustrating one possible format for the logical address (LA) provided from the host of FIG. 2.

FIG. 6 is a diagram further describing operation of the CPU of FIG. 2 in relation to the LA of FIG. 5.

FIG. 7 is a conceptual diagram further illustrating operation and use of the de-duplication (management) table of FIG. 2.

FIG. 8 is a diagram further illustrating the use of the mapping table of FIG. 2.

FIGS. 9, 10 and 11 are conceptual diagrams variously describing operation of a storage device according to embodiment(s) of the inventive concept.

FIG. 12 is a flowchart summarizing one possible approach to the operation of a storage device according to an embodiment of the inventive concept during a write operation.

FIGS. 13 and 14 are diagrams further describing the operation of a storage device according to an embodiment of the inventive concept during an erase operation.

FIG. 15 is a flowchart summarizing one possible approach to the operation of a storage device according to an embodiment of the inventive concept during an erase operation.

FIG. 16 is a block diagram illustrating a memory system according to another embodiment of the inventive concept.

FIG. 17 is a block diagram illustrating a memory system according to still another embodiment of the inventive concept.

FIG. 18 is a block diagram illustrating a memory card system to which a memory system according to the inventive concept is applied.

FIG. 19 is a block diagram illustrating a solid state drive including a memory system according to an embodiment of the inventive concept.

FIG. 20 is a block diagram further illustrating the SSD controller of FIG. 19.

FIG. 21 is a block diagram illustrating a flash memory module according to an embodiment of the inventive concept.

### DETAILED DESCRIPTION

The inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings, like reference numbers and labels are used to denote like or similar elements.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

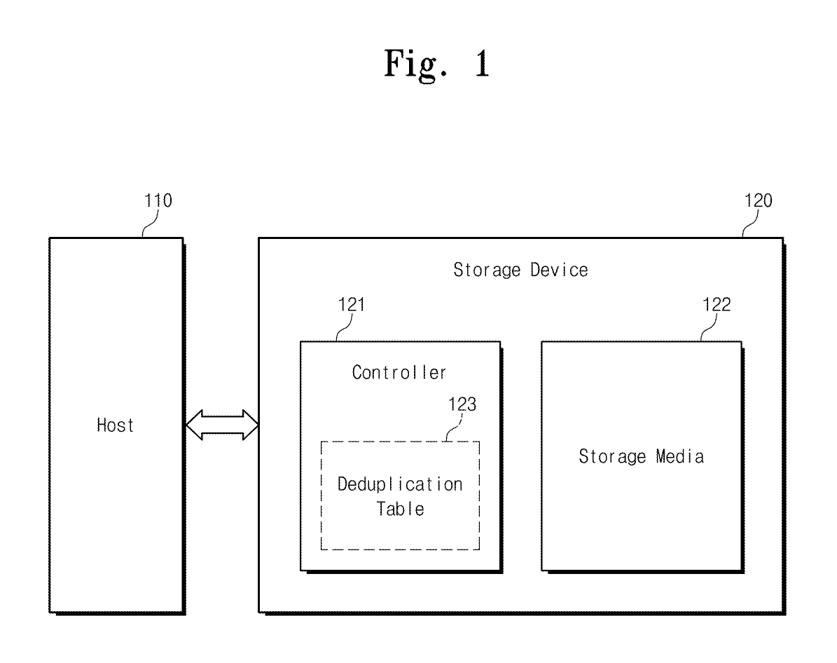

FIG. 1 is a block diagram illustrating a memory system according to an embodiment of the inventive concept. Referring to FIG. 1, a memory system 100 generally comprises a host 110 and a storage device 120.

The storage device 120 comprises a controller 121 and a storage media 122. The controller 121 controls the overall operation of the storage device 120 to store data in the storage media 122. In response to a read request received from the host 110, the storage device 120 will retrieve “read data” stored in the storage media 122 to send it to the host 110. In response to a write request received from the host 110 including “write-requested data”, the storage device 120 will normally cause the write-requested data to be appropriately stored in the storage media. However, some write-requested data will be identical to data already stored in the storage media 122. Under such circumstances, the write-requested data may be deemed “duplicate write data”.

Ideally, upon determining that write-requested data is identical to data previously stored in the storage media 122, the storage device 120 will not normally execute the requested write operation and essentially duplicate the write-requested data in the storage media 122. Rather, under these circumstances, the storage device 120 may process the “current write request” received from the host 110 by “harmonizing” (i.e., making identical) an address for the write-requested data with an address for the previously stored data. Following address harmonization, the previously stored data essentially becomes the write-requested data during subsequent read/write/erase operations. This entire operation may be referred to as “a de-duplication operation”. As will be appreciated, the storage device 120 may make better use of available memory space provided by the storage media 122 using appropriate de-duplication operation(s).

As generally indicated by the block diagram of FIG. 1, a de-duplication management table 123 (hereafter, simply “duplication table”) may be use during execution of de-duplication operations. Thus, in response to a write request received from the host 110, the storage device 120 may determine whether the write-request data is identical to previously stored data in the storage media 122 with reference to the de-duplication table 123. As will be described hereafter, the de-duplication table 123 is able to manage “identification information” effectively identifying all previously stored data in the storage media 122.

However, if identification information for all data stored in the storage media 122 were managed by the de-duplication table 123, the de-duplication table 123 would become in many instance quite large. For example, if the storage media 122 is implemented from 1 TB of flash memory, the de-duplication table 123 might contain 4 GB of identification information. This type of requirement is clearly unacceptable, since an overly large de-duplication table 123 will cause long delays in data processing.

However, consistent with certain embodiment of the inventive concept, the storage device 120 of FIG. 1 may implement and control the de-duplication table 123 using much less memory space. For example, the storage device 120 may control the de-duplication table 123 to more effectively manage identification information for stored data by designating some portion of the stored data as “recent write data”, and another portion of the store data as “recently read data”. Such designations allow the size of the de-duplication table 123 to be better restrained.

In general, only a limited region with the overall memory space will be accessed (written to, read from, or erased) during any given period. This practical outcome may be referred to as “locality of reference”. Hence, an accessed region within memory may be referred to by its particular access time (effectively, a time stamp for the accessed region). This practical outcome may be referred to as “temporal locality”.

Although identification information for all data stored in the storage media 122 may not be reasonably managed, the storage device 120 of FIG. 1 may nonetheless detect duplication write data with a high probability of success by managing identification information indicating recent write data and/or recent read data using the de-duplication table 123 in view of locality of reference and temporal locality. In this manner, the storage device 120 may make efficient use of available memory space provide by the storage media 122, while also maintaining a reasonable constraint upon the maximum size of the de-duplication table 123.

The storage device 120 according to certain embodiments of the inventive concept may be implemented using different types of memory to form the storage media 122. For example, the storage media 122 may be formed of a nonvolatile memory, such as flash memory, Magnetic RAM (MRAM), Spin-Transfer Torgue RAM (STT-RAM), Conductive bridging RAM (CBRAM), Ferroelectric RAM (FeRAM), Phase RAM (PRAM) referred to as Ovonic Unified Memory (OUM), Resistive RAM (RRAM or Re-RAM), Nanotube RAM, Polymer RAM (PoRAM), Nano Floating Gate Memory (NFGM), holographic memory, molecular electronics memory, and/or insulator resistance change memory.

Nonetheless, certain embodiments of the inventive concept will be described hereafter under an assumption that the storage media 122 of FIG. 1 is implemented using flash memory.

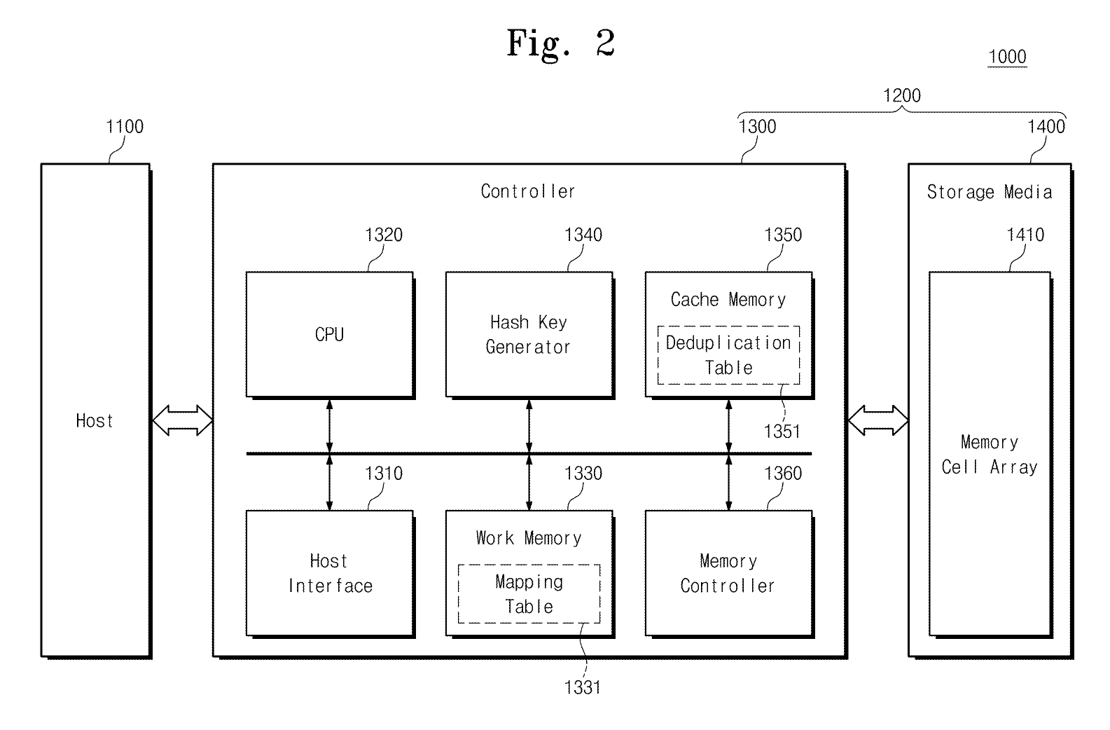

FIG. 2 is a block diagram illustrating a memory system 100 according to an embodiment of the inventive concept. The memory system 1000 generally comprises a storage device 1200 including storage media 1400 implemented with flash memory and a controller 1300, and a host 1100.

The controller 1300 may be used to control the overall operation of the storage device 1200. For example, the controller 1300 may manage write, erase, and read operations of the storage device 1200.

In response to a write request received from the host 1100, the controller 1300 will determine whether provided write-requested data is “equal to” stored data in the storage media 1400. If the write-requested data is equal to stored data in the storage media 1400, the controller 1300 will control operation of the storage device 1200 such that a logical address (LA) associated with the write-requested data is harmonized with a physical address (PA) of the corresponding (equal to) stored data in the storage media 1400. In embodiment illustrated in FIG. 2, the controller 1300 includes a host interface 1310, a CPU 1320, a work memory 1330, a hash key generator 1340, a cache memory 1350, and a memory controller 1360.

The host interface 1310 may provide an interface between the storage device 1200 and the host 1100. The CPU 1320 may control an overall operation of the controller 1300. The work memory 1330 may be used to store software needed to perform a Flash Translation Layer (FTL) function. For example, the work memory 1330 may be formed of a volatile memory such as DRAM, SDRAM, or the like. The work memory 1330 may be used to store mapping information between the storage media 1400 and the host 1100. The work memory 1330 may include a mapping table 1331.

The mapping table 1331 may manage mapping information between a logical address provided from the host 1100 and a physical address of the storage media 1400. The mapping table 1331 may manage mapping information using one of a block mapping method, a page mapping method, and a hybrid mapping method.

The hash key generator 1340 may generate a hash key on write-request data. The hash key may be used to determine duplication of data. For example, if a hash key of write-requested data is coincident with a hash key managed by a de-duplication manage table 1351, the write-requested data may be determined to duplicate with data stored in the storage media 1400.

As illustrated in FIG. 2, the hash key generator 1340 may be formed by hardware. However, the inventive concept is not limited thereto. For example, the hash key generator 1340 may be formed of software performing a hash key generating function. In this case, the software may be stored in the work memory 1330.

The cache memory 1350 may be placed between the CPU 1320 and the storage media 1400 in view of the memory hierarchical architecture. Thus, the CPU 1320 may access the cache memory 1350 in a higher speed compared with the storage media 1400. The cache memory 1350 may include a de-duplication table 1351.

The de-duplication table 1351 may be used to manage identification information for the stored data in the storage media 1400. When a write request is received from the host 1100, the CPU 1320 may refer to identification information contained in the de-duplication table 1351 to determine whether write-requested data received with the write request is equal to stored data in the storage media 1400 (i.e., whether the write-request data is duplicate write data).

However, within the context of the inventive concept, the size of the de-duplication table 1351 may be relatively limited to a predetermined size. For example, the de-duplication table 1351 may manage identification information for only recent write data and/or recent read data from among all of the data stored in the storage media 1400. Hence, if identification information to be stored in the de-duplication table 1351 would exceed available memory space, the CPU 132 may delete certain identification information deemed to be the “oldest” identification information (i.e., identification information associated with stored data having the oldest time stamp). However, the inventive concept is not limited thereto. For example, the CPU 1320 may alternately and/or additionally delete identification information associated with stored data have a lowest access frequency in order to avoid an overflow of stored identification information in the de-duplication table 1351.

In the working example of FIG. 2, the memory controller 1360 may manage the overall operation of the storage media 1400.

The storage media 1400 may include a memory cell array 1410. For example, the memory cell array 1410 may include a plurality of memory blocks, each of which has a plurality of flash memory cells. Each flash memory cell may store one or more bits of data. The mapping table 1331 and the de-duplication table 1351 may be periodically stored in the storage media 1400, upon power-off of the memory system 1000, and/or upon loading of the work memory 1330 and cache memory 1350 when the storage device 1200 is powered-on.

Within the context of the storage device 1200 of FIG. 2, if write-requested data is equal to stored data in the storage media 1400, its corresponding logical address (LA) may be mapped to the physical address of the stored data in the storage media 1400. Thus, it is possible to prevent the duplicate data from being stored in the storage media 1400.

In order to perform the de-duplication operation, the de-duplication table 1351 may manage only identification information for recent write data and/or recent read data. In certain embodiments of the inventive concept, the identification information stored in the de-duplication table 1351 may be a hash key. That is, upon receiving a write request from the host 1100, the hash key generator 1340 may be used to generate a unique hash key for the write-requested data, then the CPU 1320 may be used to determine with reference to the hash key whether the write-requested data is duplicate data by comparing the newly generated hash key with all hash keys stored in the de-duplication table 1351.

In a case where only a logical address is provided by the host 1100, the CPU 1320 may determine whether data corresponding to the provided logical address is stored data by referencing the de-duplication table 1351. Thus, if an erase request directed to stored data in the storage media 1400 is received from the host 1100, the CPU 1320 may delete both the erase-requested data in the storage media 1400 and the corresponding identification information for the erase-requested data.

Hence, the de-duplication table 1351 may be formed using a double linked approach. That is, the de-duplication table 1351 may include a first table and a second table, where the first table is used to manage identification information that allows a determination of whether write-requested data is equal to stored data in the storage media 1400, and the second stable is used to manage identification information that allows a determination as to whether a logical address associated with the erase-requested data is equal to data being managed by a hash manage table. Hereinafter, the first table may be referred to as a “hash manage table”, and the second table may be referred to as an “LBA manage table”, wherein the hash manage table and LBA manage table are interlinked.

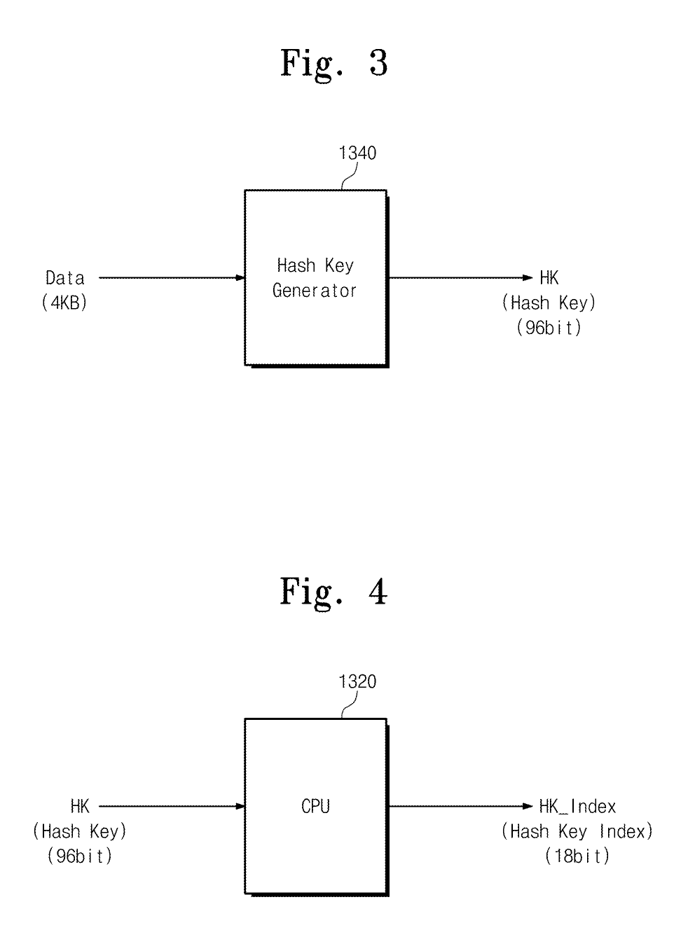

The hash key generator 1340 and the CPU 1320 will be more fully described with reference to FIGS. 3 to 8. Further, the hash manage table and the LBA manage table of the de-duplication manage table 1341 will be more fully described hereafter.

FIG. 3 is a diagram describing operation of the hash key generator 1340 of FIG. 2. FIG. 4 is a diagram describing operation of the CPU 1320 of FIG. 2. Below, hash keys constituting a hash manage table of a de-duplication table 1351 and a corresponding hash index generating operation will be described with reference to FIGS. 2, 3 and 4.

Referring to FIG. 3, the hash key generator 1340 receives write-requested data and generates a hash key HK corresponding to the write-requested data. For example, the hash key generator 1340 may receive write-requested data of 4 KB to generate a 96-bit hash key HK corresponding to the write-requested data.

Referring to FIG. 4, the CPU 1320 receives the hash key HK from the hash key generator 1340. The CPU 1320 may select a lower bit of the input hash key HK to generate a hash index HK_Index. For example, the CPU 1320 may generate the hash key index HK_Index by selecting 18 lower bits of the 96-bit hash key HK.

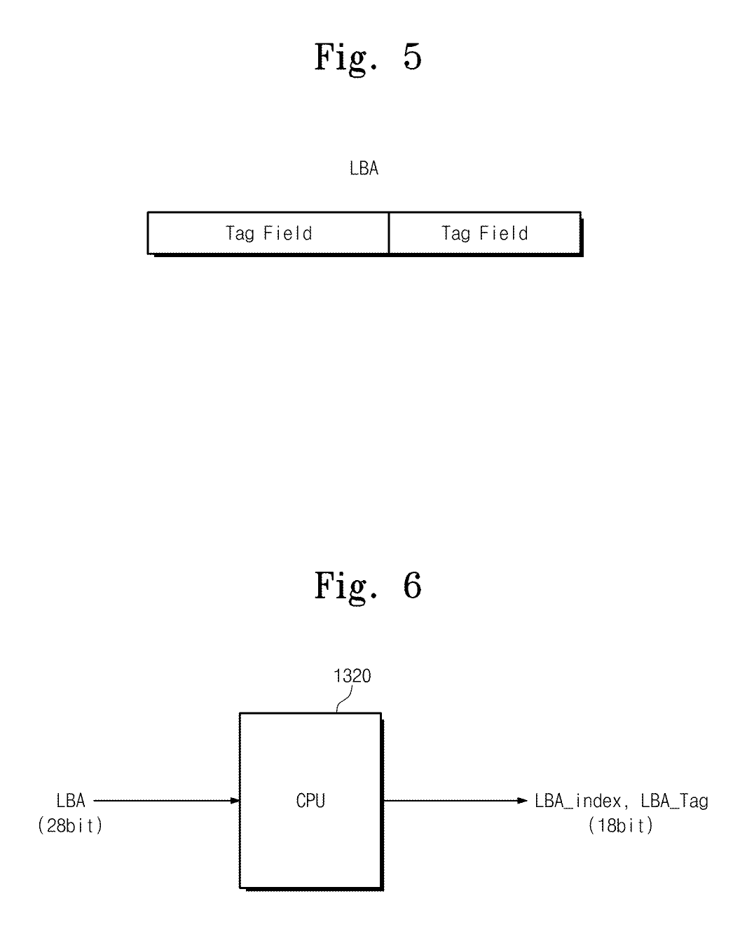

FIG. 5 is a diagram illustrating one possible format for a logical address provided with the write-request data from the host 1100 of FIG. 2. FIG. 6 is a diagram describing one possible mode of operation for the CPU 1320 of FIG. 2. LBA indexes constituting an LBA manage table of the de-duplication table 1351, and an LBA tag generating operation will be described with reference to FIGS. 5 and 6. For ease of description, it is assumed that a logical address provided from a host 1100 is a memory block unit of a flash memory.

Referring to FIG. 5, a logical block address LBA provided from the host 1100 may include a tag field and an index field. For example, in case that a logical block address LBA provided from the host 1100 is ‘0x70’, a tag field and an index field may be ‘0x7’ and ‘1’, respectively.

Referring to FIG. 6, the CPU 1320 may receive a logical block address LBA from the host 1100, and generate an LBA index and an LBA tag by selecting a lower bit of the logical block address LBA. For example, the CPU 1320 may generate the LBA index and the LBA tag by selecting 18 lower bits of a 28-bit logical block address LBA. In case that a logical block address LBA is ‘0x70’, ‘0’ may be selected as the LBA index, and ‘7’ may be selected as the LBA tag.

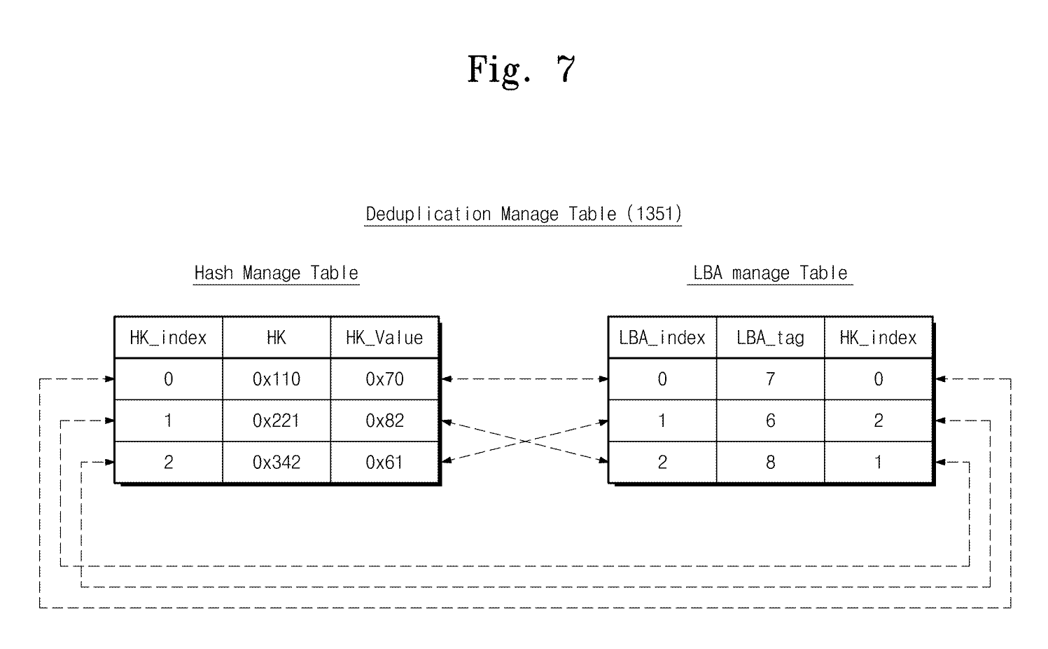

FIG. 7 is a diagram illustrating a de-duplication manage table in FIG. 2. Referring to FIG. 7, a de-duplication table 1351 may include a hash manage table and an LBA manage table. For ease of description, it is assumed that data of a memory cell array 1410 and data of the de-duplication table 1351 are managed on a block unit basis.

The hash manage table may be used to manage information associated with a hash index HK_Index, information associated with a hash key HK, and information associated with a logical block address LBA.

The hash index HK_Index may be used as an address for accessing the hash manage table, and the hash key HK may be used to determine duplication between write-requested data from the host 1100 and data stored in a storage media 1400. A logical block address LBA may be used to form a link with the LBA manage table.

In the hash manage table, a hash index HK_Index, a hash key HK, and a logical block address LBA in a same row may constitute a hash entry. For example, in a hash entry having a hash index of ‘0’, a hash key HK and a logical block address LBA may be ‘0x110’ and a 0x70’, respectively.

The LBA manage table may be used to manage information associated with an LBA index, information associated with an LBA tag, and information associated with a hash index HK_Index.

The LBA index LBA_Index may be used as an address for accessing the LBA manage table, and the LBA tag LBA_Tag may be used to determine whether a logical block address for an erase operation requested by the host 1100 belongs to a table managed at the hash manage table. The hash index HK_Index may be used to form a link between the LBA manage table and the hash manage table.

In the LBA manage table, an LBA index LBA_Index, an LBA tag LBA_Tag, and a hash index HK_Index in the same row may constitute an LBA entry. For example, in an LBA entry having an LBA index LBA_Index of ‘0’, an LBA tag LBA_Tag and a hash index HK_Index may be ‘7’ and ‘0’, respectively.

As illustrated in FIG. 7, each entry of the hash manage table may be linked to a corresponding entry of the LBA manage table via a logical block address LBA. Further, each entry of the LBA manage table may be linked to a corresponding entry of the hash manage table via a hash index HK_Index. Thus, the hash manage table and the LBA manage table may be double linked. That is, the de-duplication manage table 1351 may have a double linked structure.

In the illustrated embodiments above, since the hash manage table and the LBA manage table are double linked, they may be updated at the same time. Thus, with the double linked structure of the de-duplication table 1351, it is possible to effectively support a de-duplication operation as executed by the storage device 1200.

In a case where a write request is received from the host 1100, the CPU 1320 may refer to a hash manage table in order to determine whether the corresponding write-requested data is equal to stored data in the storage media 1400. If write-requested data is not equal to (i.e., not previously stored) stored data in the storage media 1400, the CPU 1320 may respectively add a new hash entry and a new LBA entry to the hash manage table and LBA manage table to thereafter manage identification information corresponding to the write-request data.

In a case where an erase request is received from the host 1100, the CPU 1320 may refer to an LBA manage table to determine whether erase-requested data is data managed by (or indicated within) the hash manage table. If the erase-requested data is determined to be data managed by the hash manage table, the CPU 1320 may respectively delete a hash entry and an LBA entry for the erase-requested data from the hash manage table and the LBA manage table such that erase-requested data is no longer managed.

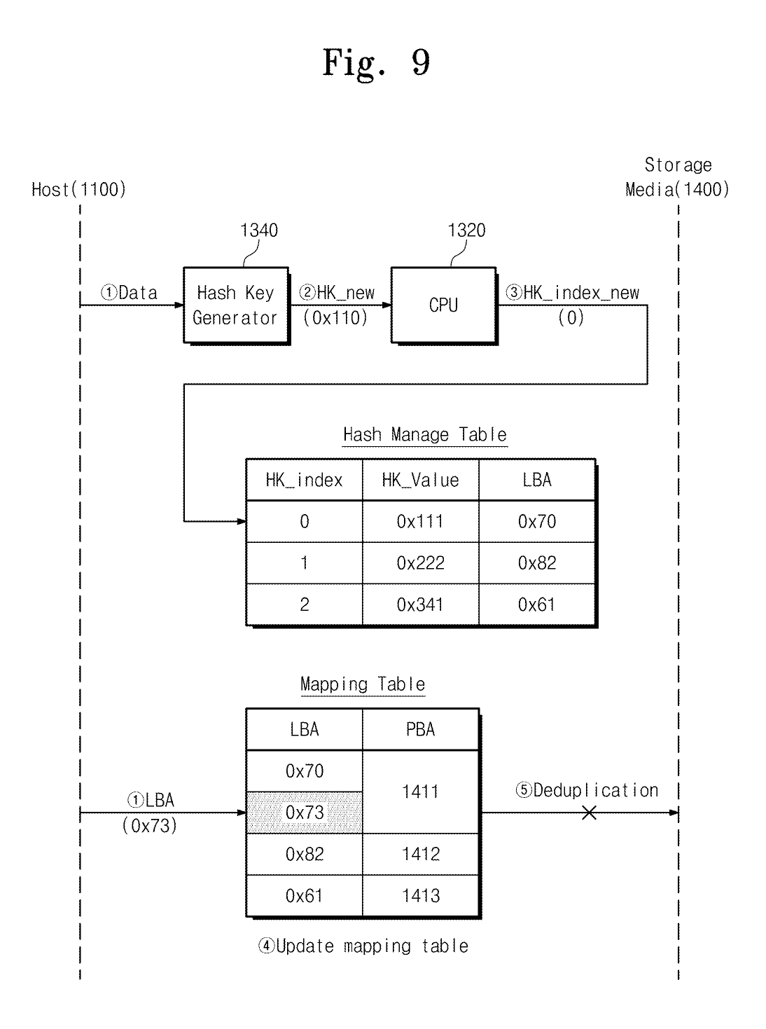

One possible approach to the management operation of a hash manage table and an LBA manage table in response to a write request received from a host 1100 will be more fully described with reference to FIGS. 9 to 12. One possible approach to the management of the hash manage table and LBA manage table in response to an erase request received from the host 1100 will be more fully described with reference to FIGS. 13 to 15.

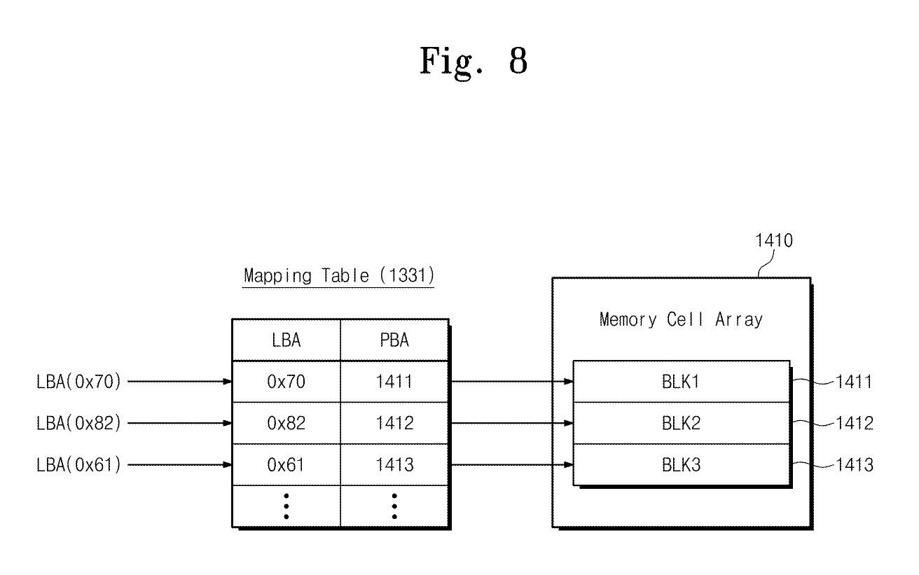

FIG. 8 is a diagram further illustrating the mapping table 1331 of FIG. 2. Like FIG. 7, for ease of description, it is assumed that data of the memory cell array 1410 and the mapping table 1331 are managed by a block unit basis. Referring to FIG. 8, a logical block address LBA received from the host 1100 may be mapped on a physical block address PBA of the memory block via the mapping table 1331.

FIG. 9 is a conceptual diagram describing one possible operation for a storage device according to an embodiment of the inventive concept. In FIG. 9, there is illustrated a case wherein a write requested is received from the host including write-request data having been previously stored in the storage media 1400. For ease of description, it is further assumed that the storage media 1400, de-duplication table 1351, and mapping table 1331 are managed by a block unit basis. It is also assumed that information managed by the de-duplication manage table 1351 and mapping table 1331 before a write request are identical to that managed by the de-duplication table of FIG. 7 and the mapping table of FIG. 8.

Referring to FIG. 9, write-requested data and a logical block address LBA corresponding to the write-requested data received from the host 1100 are then provided to the storage device 1200. The hash key generator 1340 receives the write-requested data and generates a corresponding hash key. For ease of description, it is assumed that a hash key generated by the hash key generator 1340 is referred to as a “new hash key” (HK_new) and has a value of ‘0x10’.

The CPU 1320 then receives the new hash key HK_new, and generates a hash index by selecting a lower bit of a value of the new hash key HK_new. For ease of description, it is assumed that a hash index corresponding to the new hash key HK_new is referred to as a “new hash index” (HK_Index_new) and has a value of ‘0’.

In case that the new hash index HK_Index_new has a value of ‘0’, the CPU 1320 may access a cache memory 1350 to determine whether a hash manage table stored in the cache memory 1350 has a hash entry, having a hash index of ‘0’, from among its hash entries.

In case that a hash entry having a hash index of ‘0’ exists, the CPU 1320 may compare a hash key (HK) value of a corresponding hash entry with a new hash key (HK_new) value. As illustrated in FIG. 9, since the hash key HK of a corresponding hash entry and the new hash key HK_new have the same value of ‘0x110’, the write-requested data may be determined to be stored in a storage media 1400 by the CPU 1320.

In this case, the CPU 1320 may update the mapping table 1331 such that a logical block address for the write-requested data is mapped on a physical block address of the storage media 1400 in which previously stored data equal to the write-requested data was stored.

As illustrated in FIG. 9, the logical block address LBA of the write-requested data may be ‘0x73’ and logical and physical block addresses LBA and PBA of the same data as the write-requested data may be ‘0x70’ and ‘141’, respectively. Thus, the CPU 1320 may update the mapping table 1331 such that ‘0x73’ being a logical block address LBA of the write-requested data is mapped on ‘1411’ being a physical block address.

As described above, the storage device 1200 according to an embodiment of the inventive concept may determine whether write-requested data is equal to stored data in the storage media 1400 by referencing a hash manage table. In a case that a hash key corresponding to the write-requested data is equal to a hash key managed at a hash manage table, the storage device 1200 may prevent the duplicate data from being stored in the storage media 1400.

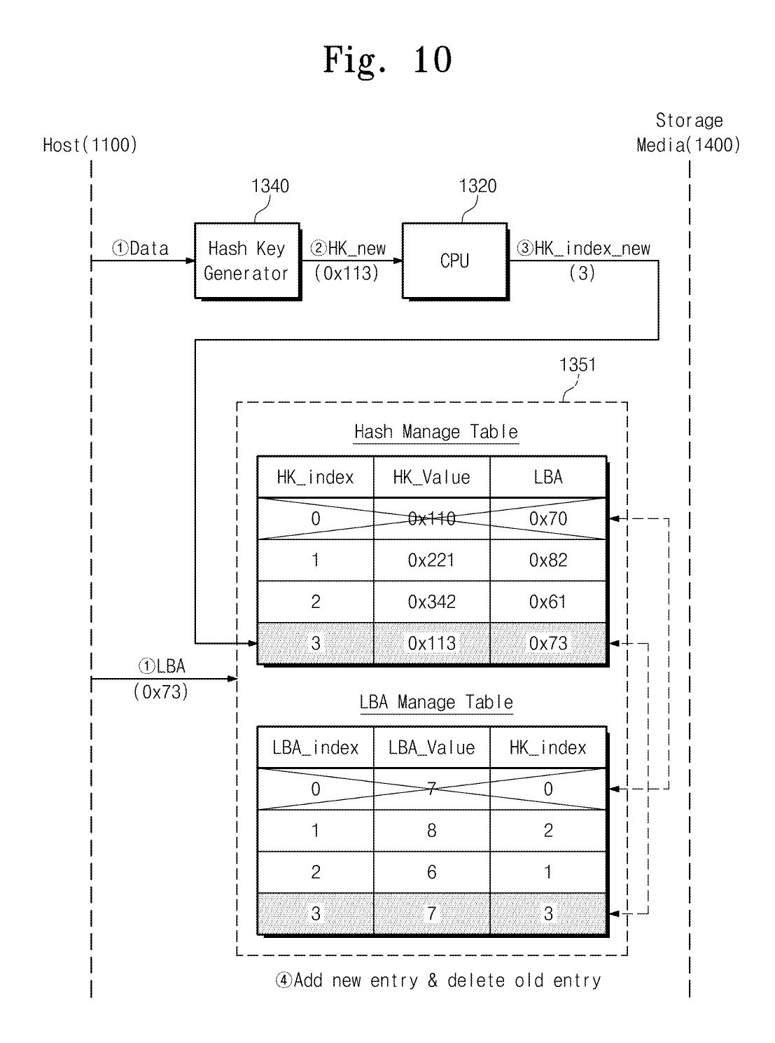

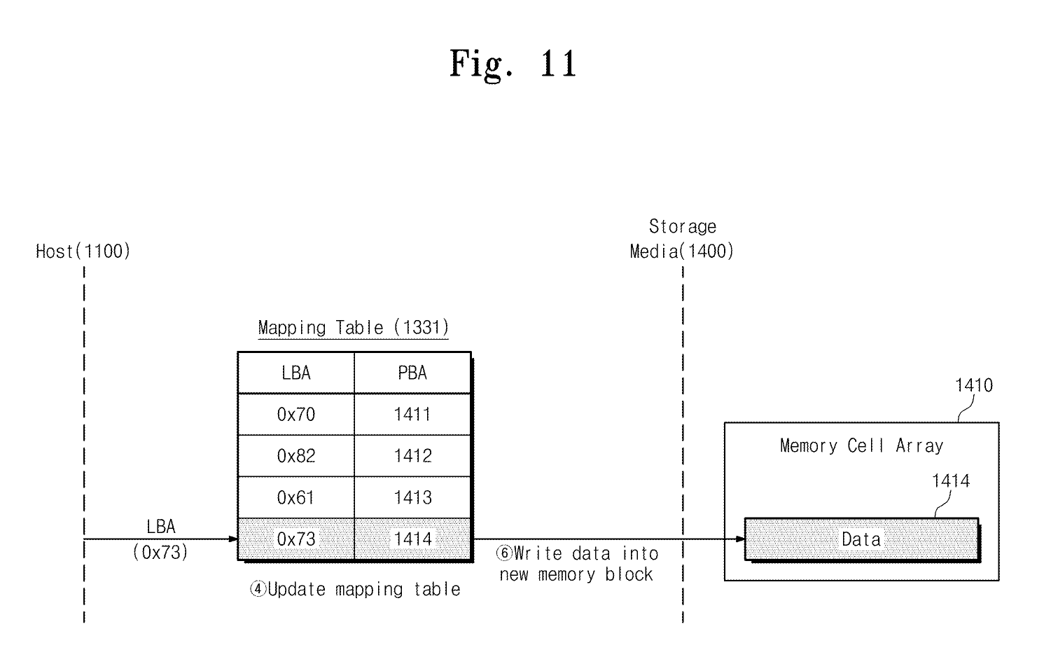

FIGS. 10 and 11 are diagrams describing one possible operation for a storage device according to another embodiment of the inventive concept. In FIGS. 10 and 11, there is illustrated a case wherein write-requested data received from the host 1100 is not equal to stored data in the storage media 1400 (i.e., is not the same as data previously stored to the storage media 1400).

For ease of description, it is assumed that the storage media 1400, de-duplication table 1351, and mapping table 1331 are managed on a block unit basis. It is also assumed that information managed by the de-duplication manage table 1351 and mapping table 1331 before the write request are identical to that managed by the de-duplication table of FIG. 7 and mapping table of FIG. 8.

Referring to FIG. 10, the hash key generator 1340 may receive write-requested data to generate a new hash key HK_new corresponding to the write-requested data. The CPU 1320 may receive the new hash key HK_new, and may generate a new hash index HK_Index_new by selecting a lower bit of a value of the new hash key HK_new. For ease of description, it is assumed that the new hash key HK_new has a value of ‘0x113’ and the new hash index HK_Index_new has a value of ‘3’.

Afterwards, the CPU 1320 may access a hash manage table to determine whether a hash entry having a hash index of ‘3’ exists. As illustrated in FIG. 10, since a hash entry having a hash index of ‘3’ does not exist, the write-requested data may be determined not to be stored in the storage media 1400, by the CPU 1320.

In this case, the CPU 1320 may add a new entry to the hash manage table to as to include identification information on the write-requested data. That is, as illustrated in FIG. 10, the CPU 1320 may add a hash entry having a hash index HK_Index of ‘3’, a hash key (HK) value of ‘0x113’, and a logical block address LBA of ‘0x73’, to the hash manage table.

In this case, the CPU 1320 may further add an LBA entry corresponding to a newly added hash entry to an LBA manage table. That is, as illustrated in FIG. 10, the CPU 1320 may add an LBA entry having an LBA index LBA_Index of ‘3’, an LBA tag LBA_Tag of ‘7’, and a hash index HK_Index of ‘3’, to the LBA manage table. Thus, the newly added hash entry and the newly added LBA entry may be interlinked.

In a case where a new hash entry and an LBA entry are added, the CPU 1320 may update the hash manage table and the LBA manage table such that certain oldest hash and LBA entries are deleted. This enables the size of the de-duplication table 1351 to be maintained at a relatively small size.

For ease of description, it is assumed that a hash manage table and an LBA manage table are managed to maintain three hash entries and three LBA entries, respectively. It is also assumed that a hash entry having a hash index HK_Index of ‘0’ and an LBA entry having an LBA index LBA_Index of ‘0’ were earliest referred. As illustrated in FIG. 10, in case that a new hash entry and a new LBA entry are added, the CPU 1320 may retain sizes of the hash manage table and the LBA manage table by deleting the earliest referred (“oldest”) hash entry having a hash index HK_Index of ‘0’ and the earliest referred (“oldest”) LBA entry having an LBA index LBA_Index of ‘0’.

Since write-requested data is duplicate data, it may be stored in the storage media 1400. Thus, as illustrated in FIG. 11, a logical block address LBA of the write-requested data may be mapped on a physical block address PBA of a free block of the memory cell array 1410 via the mapping table 1331, and the write-requested data may be stored in the block 1414 of the memory cell array 1410.

As described with reference to FIGS. 10 and 11, the storage device 1200 according to an embodiment of the inventive concept may determine whether write-requested data is equal to stored data in the storage media 1400 with reference to a hash manage table.

If a hash key of write-requested data is equal to a hash key managed at a hash manage table, the storage device 1200 may update the mapping table 1331 instead of storing the write-requested data in the storage media 1400. Thus, the storage device 1200 may prevent duplicate data from being stored in the storage media 1400.

When a hash key for write-requested data is not equal to a hash key managed at a hash manage table, the storage device 1200 may add a new hash entry and a new LBA entry to a hash manage table and an LBA manage table, and may delete the earliest referred hash entry and the earliest referred LBA entry from the hash manage table and the LBA manage table, respectively. The de-duplication table 1351 may be managed within a predetermined size constraint.

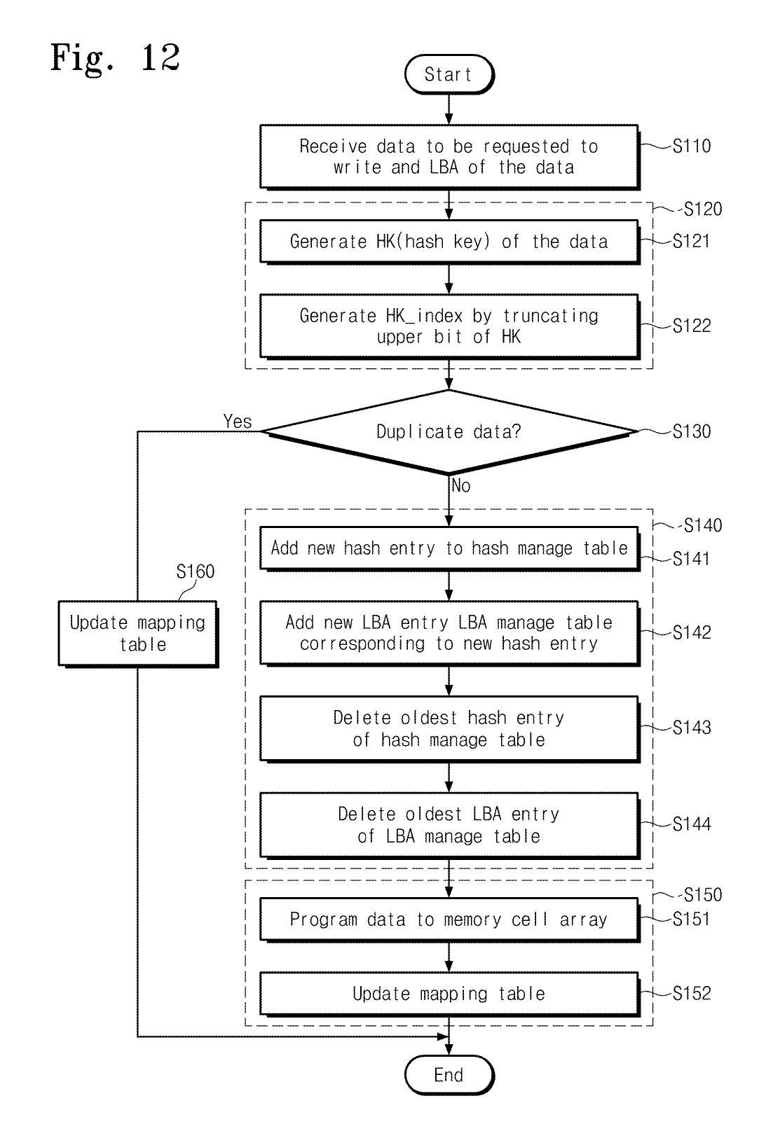

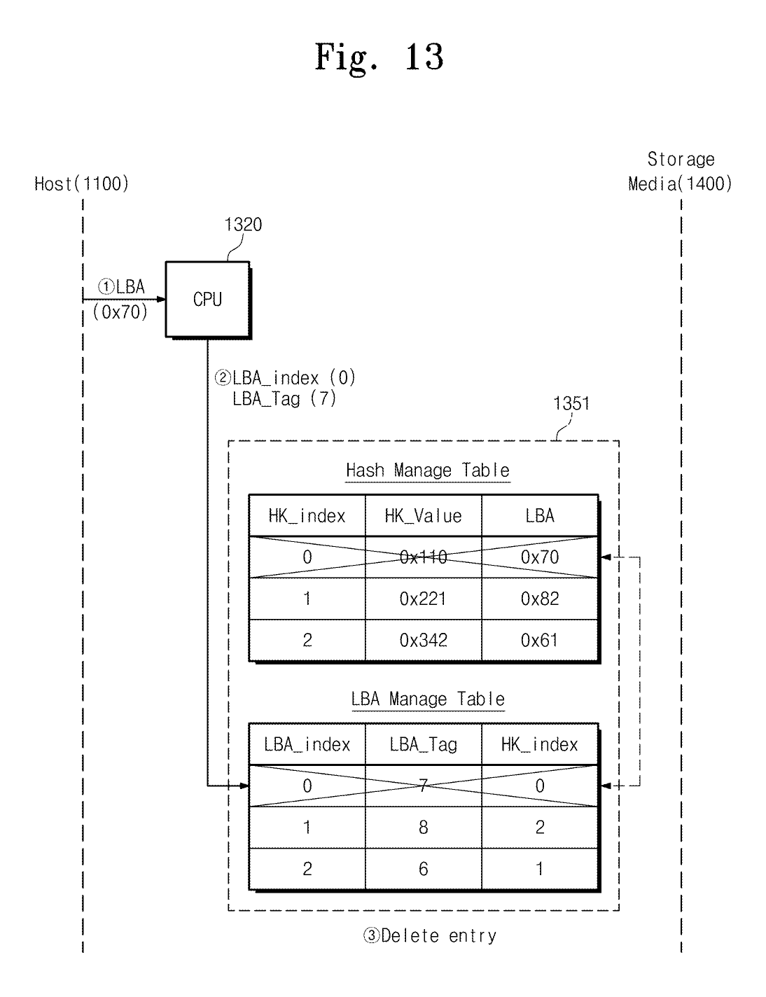

FIG. 12 is a flowchart summarizing one possible operation for a storage device according to an embodiment of the inventive concept when a write operation is requested. This operation of the storage device 1200 will be more fully described with reference to FIGS. 2 and 12.

First, write-requested data and a logical block address LBA corresponding thereto are received by the storage device 1200 (S110).

Then, an operation generating identification information associated with the write-requested data is be carried out (S120). In the illustrated example this includes: the hash key generator 1340 generating a hash key HK on the write-requested data (S121) and the CPU 1320 generating a hash index HK_Index by deleting a upper bit value of the hash key HK, that is, selecting a lower bit value thereof (S122).

Then, a determination is made as to whether the write-requested data is equal to stored data in a storage media 1400 (S130). That is, the CPU 1320 may determine whether the same hash key as a hash key of the write-requested data exists within a hash manage table.

When the write-requested data is not duplicate data (S130=NO), an operation of updating the de-duplication table 1351 is performed (S140), otherwise the mapping table is updated (S160) when the write-requested data in duplicate data (S140=YES).

In particular, the of updating the de-duplication table 1351 (S140) includes in the illustrated embodiment, adding a new hash entry on the write-requested data to the hash manage table (S141), adding a new LBA entry corresponding to the new hash entry to the LBA manage table (S142), deleting the earliest hash entry from the hash manage table to maintain a size of the de-duplication manage table 1351 constantly (S143), and deleting the earliest LBA entry from the LBA manage table after the earliest hash entry is deleted from the hash manage table (S144).

Then, an operation storing the write-requested data in the storage media 1400 may be performed (S150). In particular, the write-requested data may be programmed to a memory block of the memory cell array 1410 (S151), and the mapping table may be updated to include mapping information between a logical block address of the write-requested data and a physical block address of a memory block in which the write-requested data is stored (S152).

If the write-requested data is duplicate data, the mapping table 1331 may be updated such that a logical block address of the write-requested data corresponds to a physical block address of data previously stored in the storage media 1400 (S160).

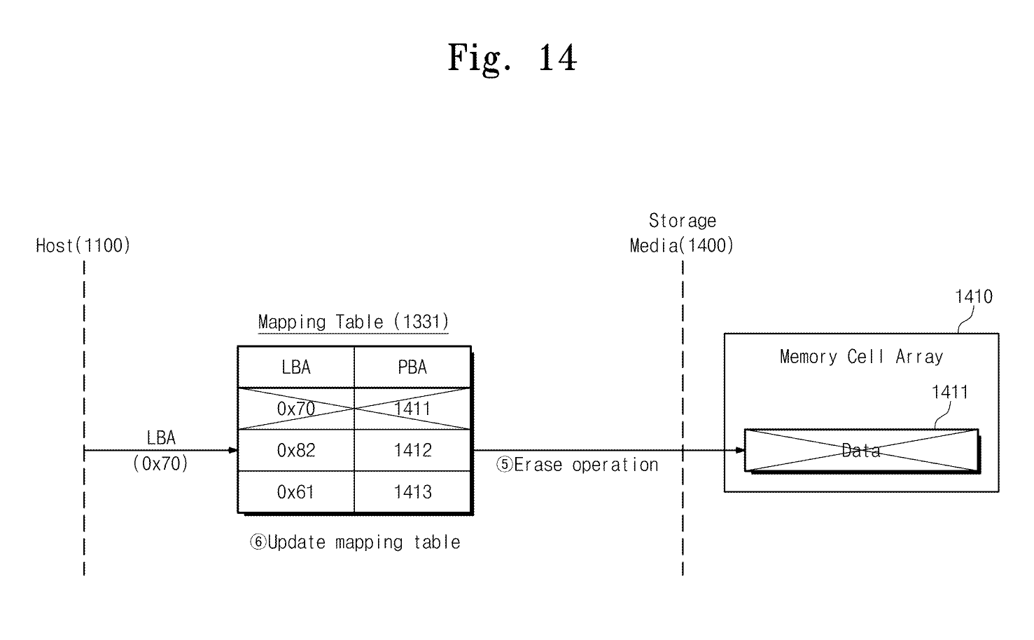

FIGS. 13 and 14 are diagrams describing one possible operation of a storage device according to an embodiment of the inventive concept when an erase operation is requested. In FIGS. 13 and 14, there is illustrated the case that a logical block address received from the host 1100 (refer to FIG. 2) is managed using the de-duplication table 1351.

For ease of description, it is again assumed that the storage media 1400, de-duplication table 1351, and mapping table 1331 are each managed on a block unit basis. It is also assumed that information managed by the de-duplication table 1351 and mapping table 1331 before the write request are identical to that managed by the de-duplication table of FIG. 7 and mapping table of FIG. 8.

Referring to FIG. 13, if an erase request is issued from the host 1100, a CPU 1320 may receive a logical block address LBA of erase-requested data from the host 1100. The CPU 1320 may generate an LBA index LBA_Index and an LBA tag LBA_Tag by selecting a lower bit value of the logical block address LBA.

For example, as illustrated in FIG. 13, when an erase-requested logical block address is ‘0x70’, the CPU 1320 may generate the LBA index LBA_Index of ‘0’ and the LBA tag LBA_Tag of ‘7’.

Afterwards, the CPU 1320 may access an LBA manage table to search whether an LBA entry having an LBA index LBA_Index of ‘0’ exists. If an LBA entry having an LBA index LBA_Index of ‘0’ exists, the CPU 1320 may search whether an LBA tag LBA_Tag of a corresponding entry is ‘7’. As illustrated in FIG. 13, since an LBA entry having an LBA index LBA_Index of ‘0’ and an LBA tag LBA_Tag of ‘7’ exists, information on the erase-requested data may be determined to be managed at the de-duplication table 1351, by the CPU 1320.

In this case, as illustrated in FIG. 10, the CPU 1320 may delete a corresponding LBA entry from the LBA manage table and a hash entry (i.e., an entry having a hash entry of ‘0’) linked with the deleted LBA entry from the hash manage table.

After deleting an LBA entry corresponding to a delete requested logical block address and a hash entry, an erase operation on data stored in the storage media 1400 may be performed. That is, as illustrated in FIG. 14, the storage device 1200 of FIG. 2 may refer to the mapping table 1331 to search a physical block address corresponding to an erase-requested logical block address such that data stored at a memory block 1411 corresponding to a physical block address is erased. Afterwards, mapping information on erased data may be deleted from the mapping table 1331.

As described in relation to FIGS. 13 and 14, when an erase request is issued from the host 1100, the storage device 1200 according to an embodiment of the inventive concept may determine whether erase-requested data is data managed at the de-duplication table 1351. If erase-requested data is data managed at the de-duplication table 1351, the storage device 1200 may delete information on erase-requested data from the de-duplication table 1351. Thus, the storage device 1200 may prevent unnecessary information from being managed at the de-duplication table 1351.

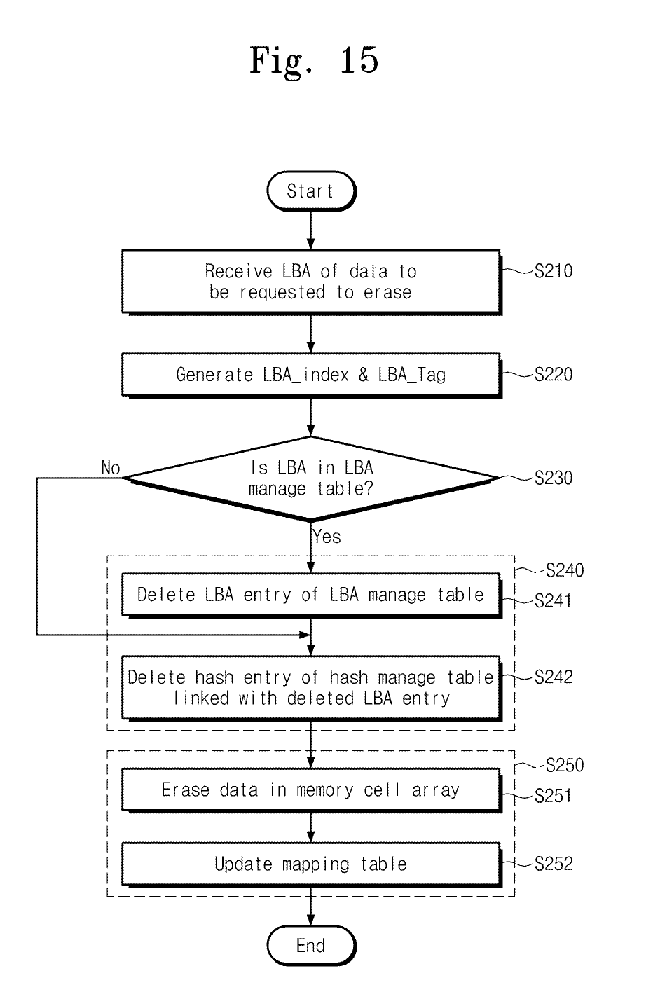

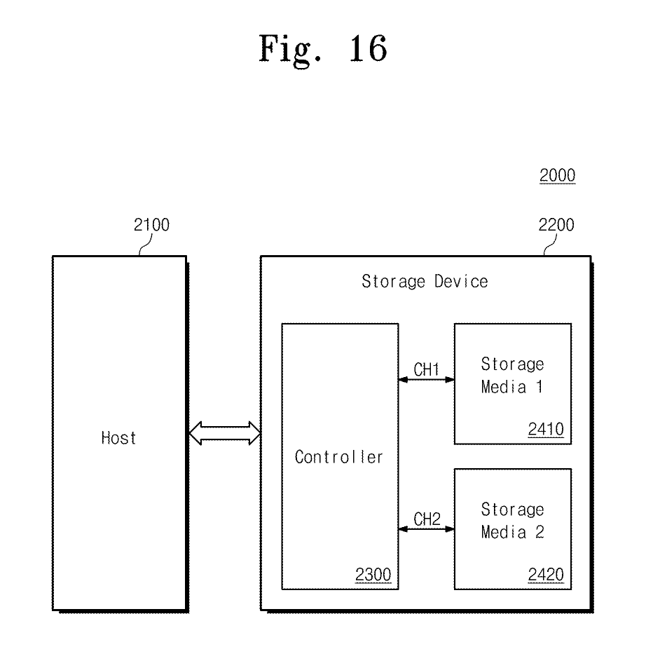

FIG. 15 is a flowchart summarizing one possible operation for a storage device according to an embodiment of the inventive concept when an erase operation is requested. Operation of the storage device 1200 according to an embodiment of the inventive concept will be more fully described with reference to FIGS. 2 and 15.

First, the storage device 1200 receives a logical block address LBA on erase-requested data (S210).

Then, the CPU 1320 generates an LBA index LBA_Index and an LBA tag LBA_Tag that are associated with the erase-requested logical block address (S220).

A determination is now made as to whether erase-requested data is managed by the LBA manage table (S230). That is, the CPU 1320 may determine whether an LBA index and an LBA tag of the erase-requested data are equal to an LBA index and an LBA tag of the LBA manage table.

If the erase-requested data is determined to be managed at an LBA manage table (S230=YES), then an update operation for the de-duplication table 1351 is performed (S240). In particular, the update operation S240 may include deleting an LBA entry associated with the erase-requested data from the LBA manage table (S241), and deleting a hash entry linked with the deleted LBA entry from the hash manage table (S242).

Then, erase-requested data of the storage media 1400 may be erased (S250). In particular this may include erasing the erase-requested data of a memory block in the memory cell array 1410 (S251), and updating a mapping table 1331 to delete mapping information between a logical block address and a physical block address of the erased data (S252).

If the erase-requested data is determined not to be managed at the LBA manage table in operation S230 (S230=NO), then the erase-requested data of the storage media 1400 may be erased.

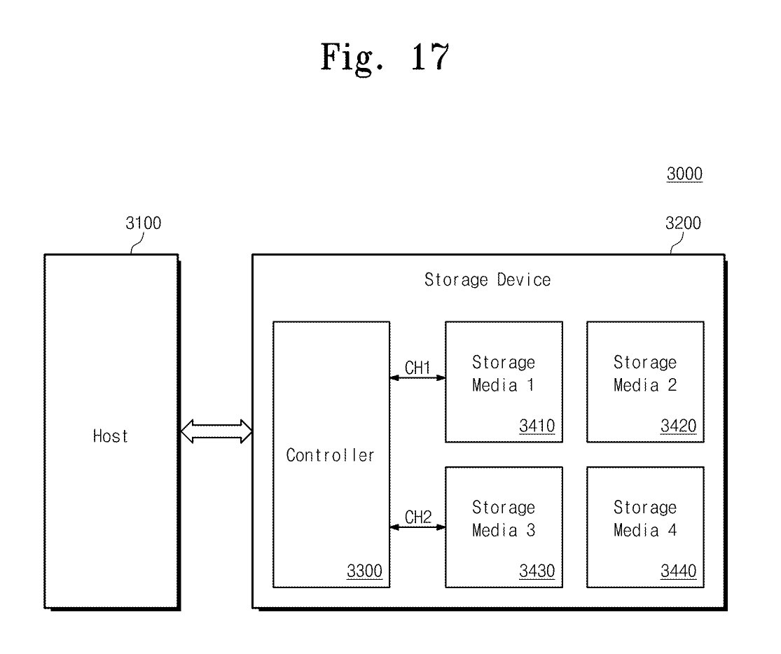

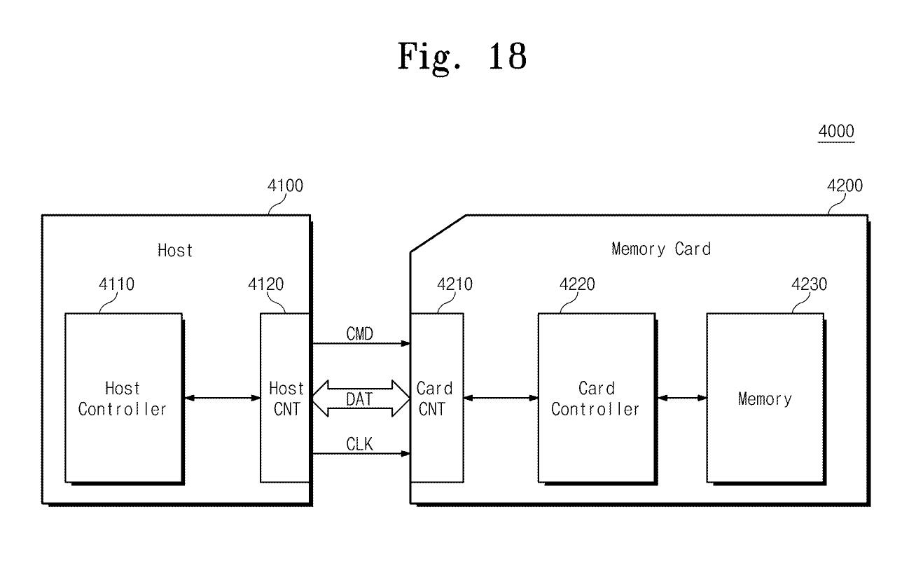

The storage device described in relation to FIGS. 2 to 16 may include a storage media. However, the inventive concept is not limited thereto. For example, a storage device according to an embodiment of the inventive concept can include a plurality of storage medias. This will be more fully described with reference to FIGS. 16 and 17.

FIG. 16 is a block diagram illustrating a memory system according to another embodiment of the inventive concept. A memory system 2000 in FIG. 16 may be similar to that 1000 in FIG. 2. In FIG. 16, constituent elements that are similar to that in FIG. 2 are marked using the same reference numbers. Below, a difference between the memory systems 1000 and 2000 in FIGS. 2 and 16 will be focused.

Referring to FIG. 16, a storage device 2200 may include a plurality of storage medias. In FIG. 16, it is assumed that the storage device 2200 includes two storage medias 2410 and 2420. A first storage media 2410 may be connected to a controller 2300 via a first channel CH1, and a second storage media 2420 may be connected to the controller 2300 via a second channel CH2. Since the first storage media 2410 and the second storage media 2420 are connected in parallel to the controller 2300 via the first channel CH1 and the second channel CH2, the controller 2300 may control the first storage media 2410 and the second storage media 2420 separately.

That is, the controller 2300 may include a de-duplication manage table associated with the first storage media 2410 and a de-duplication manage table associated with the second storage media 2420, and may perform operations, described in relation to FIGS. 2 to 15, with respect to the first storage media 2410 and the second storage media 2420, independently.

FIG. 17 is a block diagram illustrating a memory system according to still another embodiment of the inventive concept. A memory system 3000 in FIG. 17 may be similar to that 1000 in FIG. 2. In FIG. 17, constituent elements that are similar to that in FIG. 2 are marked using the same reference numbers. Below, a difference between the memory systems 1000 and 3000 in FIGS. 2 and 17 will be focused.

Referring to FIG. 17, a storage device 3200 may include a plurality of storage medias. In FIG. 17, it is assumed that the storage device 3200 includes four storage medias 3410, 3420, 3430, and 3440. First and second storage medias 3410 and 3420 may be connected to a controller 3300 via a first channel CH1, and third and fourth storage medias 3430 and 3440 may be connected to the controller 3300 via a second channel CH2.

Since the first storage media 3410 and the second storage media 3420 share the first channel CH1, the controller 3300 may control the first storage media 3410 and the second storage media 3420 at the same time. In this case, the controller 3300 may include a de-duplication manage table associated with the first storage media 3410 and the second storage media 3420, and may perform operations, described in relation to FIGS. 2 to 15, to be integrated with respect to the first storage media 3410 and the second storage media 3420.

Likewise, since the third storage media 3430 and the fourth storage media 3440 share the second channel CH2, the controller 3300 may control the third storage media 3430 and the fourth storage media 3440 at the same time. In this case, the controller 3300 may include a de-duplication manage table associated with the third storage media 3430 and the fourth storage media 3440, and may perform operations, described in relation to FIGS. 2 to 15, to be integrated with respect to the third storage media 3430 and the fourth storage media 3440.

A memory system of the inventive concept described in relation to FIGS. 1 to 17 may be applied to various products. A host may be formed of a computer, a digital camera, a handheld phone, an MP3 player, a PMP, a game machine, or the like. A storage device 1200 may be formed of a Solid State Drive (SSD), a flash memory card, or a flash memory module that is based on a flash memory. The host and the flash storage device may be connected via a standardized interface such as ATA, SATA, PATA, USB, SCSI, ESDI, PCI express, or IDE interface.

With a storage device of the inventive concept, the same data may be prevented from being stored in a storage media in duplication by determining whether write-requested data is equal to data stored in the storage media, based on a de-duplication table. Thus, it is possible to efficiently use a storage space of the storage media. Further, the memory space required to store the de-duplication table may be minimized or greatly reduced.

FIG. 18 is a block diagram illustrating a memory card system to which a memory system according to the inventive concept is applied. A memory card system 4000 may include a host 4100 and a memory card 4200. The host 4100 may include a host controller 4110 and a host connection unit 4120. The memory card 4200 may include a card connection unit 4210, a card controller 4220, and a flash memory 4230.

Each of the host connection unit 4120 and the card connection unit 4210 may be formed of a plurality of pins. The pins may include a command pin, a data pin, a clock pin, a power pin, and the like. The number of pins may differentiate according a type of the memory card 4200. For example, an SD card may have nine pins.

The host 4100 may write data in the memory card 4200 and read data from the memory card 4200. The host controller 4110 may send a command (e.g., a write command), a clock signal CLK generated from a clock generator (not shown) in the host 4100, and data to the memory card 4200 via the host connection unit 4120.

The card controller 4220 may store data in the flash memory 4230 in response to a command input via the card connection unit 4210. The data may be stored in synchronization with a clock signal generated from a clock generator (not shown) in the card controller 4220. The flash memory 4230 may store data transferred from the host 4100. For example, in a case where the host 4100 is a digital camera, the flash memory 4230 may store image data. In FIG. 18, the card controller 4220 may control the memory card 4200 to perform a de-duplication operation.

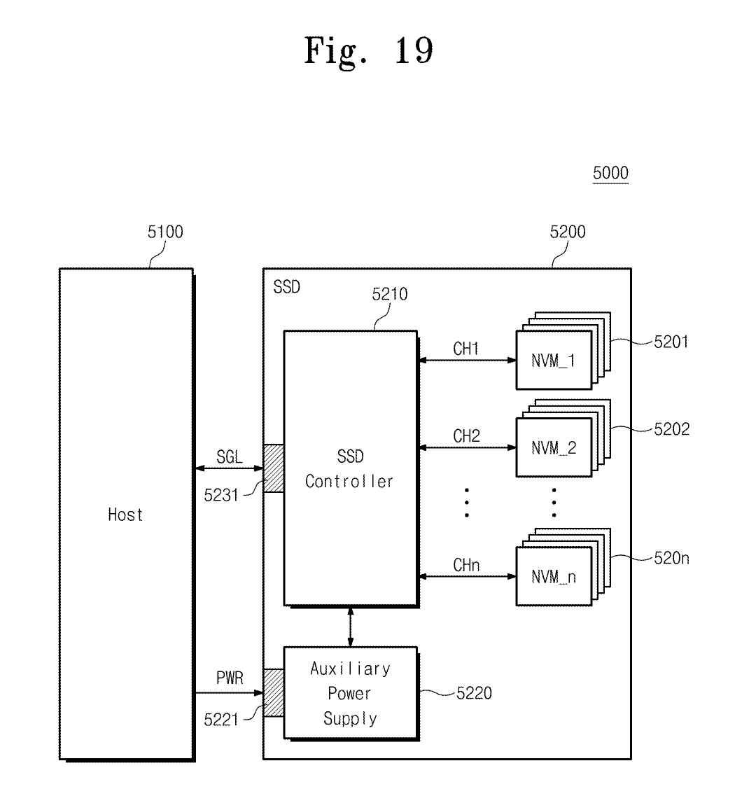

FIG. 19 is a block diagram illustrating a solid state drive (SSD) including a memory system according to an embodiment of the inventive concept. Referring to FIG. 19, a SSD system 5000 may include a host 5100 and an SSD 5200. The SSD 5200 may send and receive signals to and from the host 5100 via a signal connector 5231 and may be supplied with a power via a power connector 5221. The SSD 5200 may include a plurality of nonvolatile memory devices 5201 through 520n, an SSD controller 5210, and an auxiliary power supply 5220.

The plurality of nonvolatile memories 5201 to 520n may be used as a media of the SSD 5200. The plurality of nonvolatile memories 5201 to 520n may be implemented by a mass-storage flash memory device. The SSD 5200 may be mainly formed of a flash memory.

The plurality of nonvolatile memories 5201 to 520n may be connected with the SSD controller 5210 via a plurality of channels CH1 to CHn. One channel may be connected with one or more nonvolatile memories. Nonvolatile memories connected with one channel may be connected with the same data bus. In this case, a flash defrag may be made on the basis of a super-block in which a plurality of memory blocks are interconnected to form one block, or on the basis of a super-page in which a plurality of pages are connected to form one page.

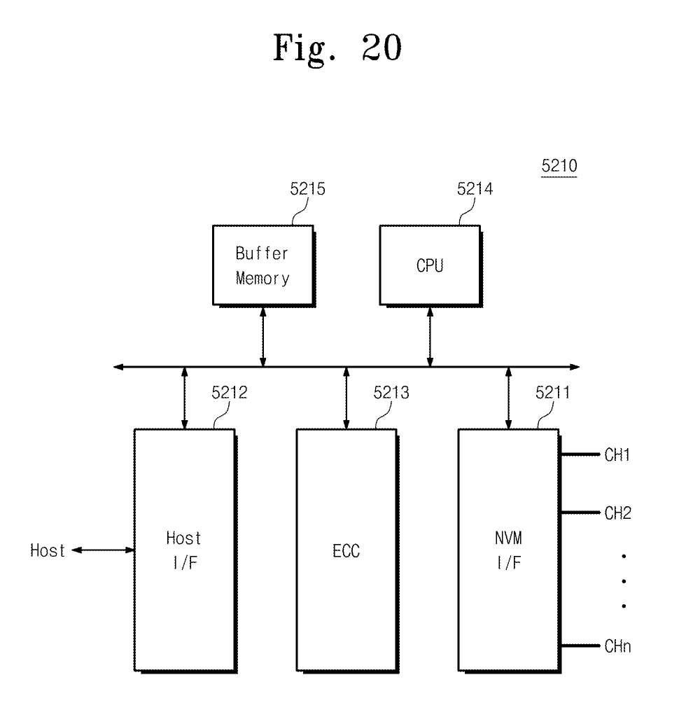

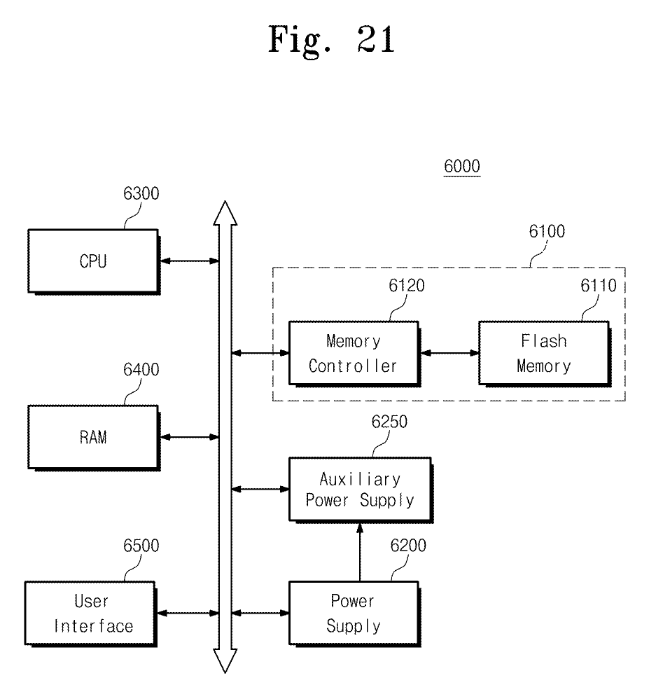

The SSD controller 5210 may exchange signals SGL with the host 5100 via the signal connector 5231. Herein, the signals SGL may include a command, an address, data, and the like. The SSD controller 5210 may be configured to write or read out data to or from a corresponding nonvolatile memory according to a command of the host 5100. The SSD controller 5210 will be more fully described with reference to FIG. 20.

The auxiliary power supply 5220 may be connected with the host 5100 via the power connector 5221. The auxiliary power supply 5220 may be charged by a power PWR from the host 5100. The auxiliary power supply 5220 may be placed within the SSD 5200 or outside the SSD 5200. For example, the auxiliary power supply 5220 may be put on a main board to supply an auxiliary power to the SSD 5200.

FIG. 20 is a block diagram illustrating an SSD controller in FIG. 19. Referring to FIG. 20, an SSD controller 5210 may include an NVM interface 5211, a host interface 5212, an ECC block 5213, a CPU 5214, and a buffer memory 5215.

The NVM interface 5211 may scatter data transferred from the buffer memory 5215 to channels CH1 to CHn, respectively. The NVM interface 5211 may transfer data read from nonvolatile memories 5201 to 520n to the buffer memory 5215. Herein, the NVM interface 5211 may use a NAND flash interface manner. That is, the SSD controller 5210 may perform a program, read, or erase operation according to the NAND flash interface manner.

The host interface 5212 may provide an interface with an SSD 5200 according to the protocol of the host 5100. The host interface 5212 may communicate with the host 5100 using USB (Universal Serial Bus), SCSI (Small Computer System Interface), PCI express, ATA, PATA (Parallel ATA), SATA (Serial ATA), SAS (Serial Attached SCSI), etc. The host interface 5212 may perform a disk emulation function which enables the host 5100 to recognize the SSD 5200 as a hard disk drive (HDD).

The CPU 5214 may parse and process a signal SGL input from the host 5100 (refer to FIG. 20). The CPU 5214 may control the host 5100 or the nonvolatile memories 5201 through 520n via the host interface 5212 or the NVM interface 5211. The CPU 5214 may control the nonvolatile memories 5201 through 520n according to firmware for driving the SSD 5200.

The buffer memory 5215 may be used to temporarily store write data provided from the host 5100 or data read from a nonvolatile memory. The buffer memory 5215 may store metadata to be stored in the nonvolatile memories 5201 through 520n or cache data. At a sudden power-off operation, metadata or cache data stored in the buffer memory 5215 may be stored in the nonvolatile memories 5201 to 520n. The buffer memory 5215 may include DRAM, SRAM, and the like.

The memory systems described with reference to FIGS. 1 to 17 may be respectively applicable to the SSD 5000 illustrated in FIGS. 19 and 20.

FIG. 21 is a block diagram schematically illustrating a flash memory module according to an embodiment of the inventive concept. Herein, a flash memory module 6000 may be connected with a personal computer, a notebook, a cellar phone, a PDA, a camera, and the like.

Referring to FIG. 21, the flash memory module 6000 may include a memory system 6100, a power supply 6200, an auxiliary power supply 6250, a CPU 6300, a RAM 6400, and a user interface 6500. A memory system described with reference to FIGS. 1 to 17 is applicable to the flash memory module 6000 in FIG. 21.

The above-disclosed subject matter is to be considered illustrative, and not restrictive, and the appended claims are intended to cover all such modifications, enhancements, and other embodiments, which fall within the scope of the following claims. Thus, to the maximum extent allowed by law, the scope is to be determined by the broadest permissible interpretation of the following claims and their equivalents, and shall not be restricted or limited by the foregoing detailed description.

What is claimed is:

1. A storage device comprising:
a controller and storage media implemented with nonvolatile semiconductor memory,
wherein the controller is configured to control access operations executed by the storage media in response to requests received from a host, and comprises;
a Central Processing Unit (CPU) that controls receipt of a write request including write-request data,
a hash key generator that provides a hash information including a new hash entry corresponding to the write-request data, and
a de-duplication table that stores and manages hash information including a plurality of hash entries for stored data in the storage media,
wherein in response to the write request, the CPU compares the new hash key with each one of the plurality of hash keys to determine whether the write-requested data is duplicate data for the stored data in the storage media.

2. The storage device of claim 1, wherein the de-duplication table comprises:
a hash manage table that manages hash information for stored data in the storage media; and
a logical address manage table that manages logical address information for the hash information managed by the hash manage table.

3. The storage device of claim 2, wherein upon receiving an erase request including erase-requested data from the host, the controller is further configured to determine whether hash information for the erase-requested data is managed by the hash manage table with reference to logical address information managed by logical address manage table.

4. The storage device of claim 3, wherein upon determining that the hash information for the erase-requested data is managed at the hash manage table, the controller is further configured to delete the hash information for the erase-requested data and logical address information for the erase-requested data from the hash manage table and the logical address manage table, respectively.

5. The storage device of claim 2, wherein if hash information for the write-requested data is equal to hash information managed by the hash manage table, the controller is further configured to add hash information for the write-requested data to the hash manage table.

6. The storage device of claim 5, wherein if hash information for the write-requested data is equal to hash information managed by the hash manage table, the controller is further configured to add logical address information for the write-requested data to the logical address manage table.

7. The storage device of claim 6, wherein before adding hash information for the write-requested data to the hash manage table and before adding logical address information for the write-requested data to the logical address manage table, the controller is further configured to delete oldest logical hash information from the has mange table, and delete oldest logical address information corresponding to the oldest hash information from the logical address manage table.

8. The storage device of claim 2, wherein each one of the plurality of hash entries includes a hash key for corresponding stored data in the storage media, a hash key index for the hash key, and a logical address for the corresponding stored data in the storage media.

9. The storage device of claim 8, wherein the logical address table includes a plurality of logical address entries, each of which includes a logical address index on the logical address information, a logical address tag on the logical address information, and the hash key index.

10. The storage device of claim 9, wherein the plurality of hash entries is linked to the plurality of logical address entries via the logical address information, respectively, and the plurality of logical address entries is linked to the plurality of hash entries via the hash key index, respectively.

11. The storage device of claim 1, wherein the controller comprises a cache memory, such that the de-duplication table is stored in the cache memory upon at least one of power-off and power-on of the storage media.

12. A method of operating a storage device comprising:
generating hash information for received write-requested data;
comparing the hash information with hash information managed by a de-duplication table to determine whether the write-requested data is duplicate data with stored data in the storage media; and
if the write-requested data is duplicate data, mapping a logical address for the write-requested data to a physical address for corresponding stored data among the stored data of the storage media using a mapping table.

13. The method of claim 12, further comprising:
adding hash information and logical address information for the write-requested data to the de-duplication table when the write-requested data is not duplicate data.

14. The method of claim 13, further comprising:
when the write-requested data is not duplicate data, deleting oldest logical hash information from the de-duplication table, and deleting oldest logical address information corresponding to the oldest hash information from the de-duplication table.

15. The method of claim 13, wherein hash information added to the de-duplication table includes a hash index for the write-requested data and a logical address for the write-requested data, and logical address information added to the de-duplication manage table includes a logical address index for the write-requested data and a hash index for the write-requested data, and
the added hash information and added logical address information being double linked via the logical address and the hash index in the de-duplication manage table.

16. A method of operating a memory system including storage media implemented with nonvolatile semiconductor memory, the method comprising:
upon power-on of the storage media, constructing a mapping table correlating logical addresses for write-requested data and physical addresses for the storage media, and constructing a de-duplication table listing hash information for each one of stored data in the storage media including at least one of recent write data and recent read data; and then,
receiving a write request including write-request data from a host;
providing new hash information for the write-request data; and
comparing the new hash information with the hash information listed in the de-duplication table to thereby determine whether or not the write-request data is duplicate data with any one of the stored data in the storage media.

17. The method of claim 16, wherein hash information includes logical address information.

18. The method of claim 17, further comprising upon determining that the write-request data is not duplicate data with any one of the stored data in the storage media, storing the new hash information in the de-duplication table, and storing the write-request data in the storage media.

19. The method of claim 17, further comprising upon determining that the write-request data is duplicate data updating the mapping table without storing the write-request data in the storage media.

20. The method of claim 17, further comprising upon determining that the write-request data is not duplicate data with any one of the stored data in the storage media, deleting oldest hash information from the de-duplication table and then storing the new hash information in the de-duplication table and storing the write-request data in the storage media.
